(19) United States
(12) Patent Application Publication
(10) Pub. No.: US 2008/0295025 A1
(43) Pub. Date: Nov. 27, 2008

(54) System and Method for Implementing Adaptive Window and Dialog Management

(76) Inventors: Wesley J. Gyure, Wake Forest, NC (US); Kevin R. Myers, Raleigh, NC (US); Adam Tate, Raleigh, NC (US)

Correspondence Address: DILLON & YUDELL LLP, 8911 N. CAPITAL OF TEXAS HWY., SUITE 2110, AUSTIN, TX, 78759, US

(21) Appl. No.: 11/753,353

(22) Filed: May 24, 2007

(51) Int. Cl. G06F 3/048

(52) U.S. Cl. 715/808

(57) ABSTRACT

A system and method for implementing adaptive window and dialog management on a data processing system. A user interface enables a user to interact with a primary program and at least one secondary program, and wherein the at least one secondary program notifies the user of at least one condition that request user attention via at least one pop-up window that steals focus from the primary program by placing the at least one pop-up window in a foreground position and redirects all user input to the at least one pop-up window. A monitor establishes usage patterns of the user while utilizing the user interface. A focus manager and adaptive engine utilize the usage patterns from the monitor to adaptively manage display of the at least one pop-up window.

### BACKGROUND OF THE INVENTION

1. Technical Field

The present invention relates in general to the field of data processing systems. More particularly, the present invention relates to a system and method of controlling user access to applications utilizing data processing systems.

2. Description of the Related Art

In current personal computing environments, applications frequently interrupt users. The interruptions usually consist of error dialogs, instant messaging (IM) windows, calendar alerts, browser pop-up windows, etc. These applications interrupt the user by “stealing focus”. “Stealing focus” occurs when a program running in the background places a window in the foreground and redirects all keyboard (or any other user interface device) input to that window. Many applications steal focus away from an application in use, or even from one of the application's own windows.

A common culprit is the instant messaging (IM) application. If a user is typing an e-mail utilizing an e-mail client, an IM dialog window pops up when the user receives an instant message from a first source. When the user receives an instant message from a second source, another IM dialog window pops up, even if the user is typing a reply to the instant message from the first source. Applications that steal focus have become a major distraction to users.

As IM applications are increasingly utilized in work environments, the problem worsens. A business user is often working on a tight deadline and/or working in several applications at once. For example, if the user is typing in a word processing application, an IM application may steal focus on the receipt of an instant message. The user may inadvertently type text into the IM dialog window when the IM application steals focus from the word processing application. The text may also be lost if the application that steals focus from the word processing application does not accept text, such as error, alert, or decision dialogs.

In the prior art, there are three primary ways that the “stealing focus” problem may be addressed:

(1) Manual: The user clicks on the window where focus is desired

Pros: High degree of user control

Cons: Requires constant user attention and intervention.

(2) Automatic (application-centric): Some individual applications will enable the user to enable/disable all pop-ups

Pros: Applications that provide the automatic pop-up control feature can ease the user's workflow regarding application focus management, but still require intermediate user interaction and interaction.

Cons: Some very critical pop-ups may be missed

(3) Automatic (system-wide): Pop-ups can be enabled/disabled for the entire environment

Pros: Requires no user attention or interaction after initial setting

Cons: All important pop-ups are missed

Therefore, there is a need for a system and method for addressing the shortcomings of the prior art regarding application focus control.

### SUMMARY OF THE INVENTION

The present invention includes a system and method for implementing adaptive window and dialog management on a data processing system. A user interface enables a user to interact with a primary program and at least one secondary program, and wherein the at least one secondary program notifies the user of at least one condition that request user attention via at least one pop-up window that steals focus from the primary program by placing the at least one pop-up window in a foreground position and redirects all user input to the at least one pop-up window. A monitor establishes usage patterns of the user while utilizing the user interface. A focus manager and adaptive engine utilize the usage patterns from the monitor to adaptively manage display of the at least one pop-up window.

All objects, features, and advantages of the present invention will become apparent in the following detailed written description.

### BRIEF DESCRIPTION OF THE FIGURES

The novel features believed characteristic of the invention are set forth in the appended claims. However, the invention, as well as a preferred mode of use, will best be understood by reference to the following detailed description of an illustrative embodiment when read in conjunction with the accompanying figures, wherein:

FIG. 1 is a block diagram illustrating an exemplary data processing system in which an embodiment of the present invention may be implemented;

FIG. 2 is a block diagram depicting exemplary contents of a system memory illustrated in FIG. 1;

FIG. 3 is a high-level logical flowchart diagram showing an exemplary method for implementing adaptive window and dialog management according to an embodiment of the present invention.

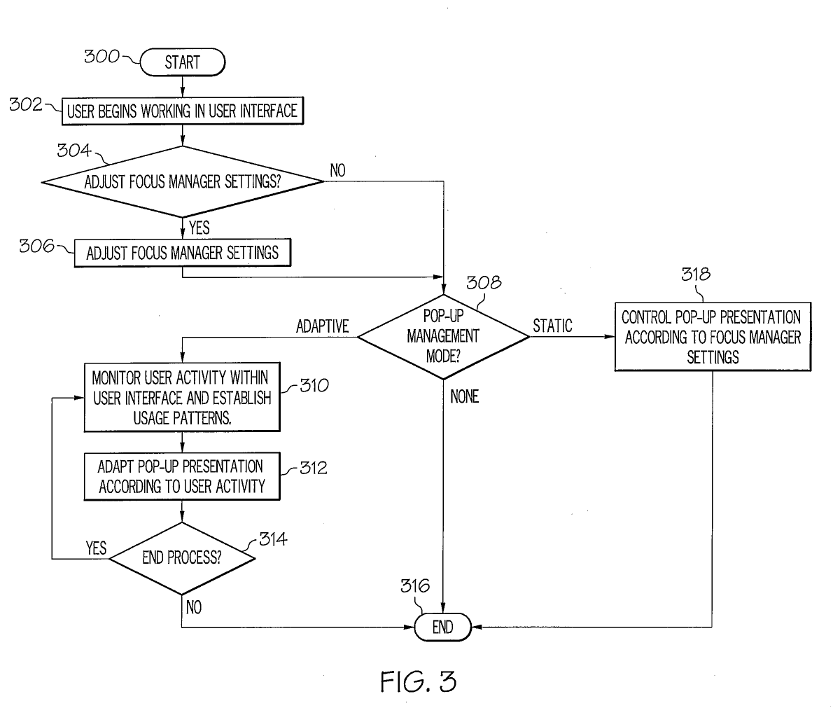

### DETAILED DESCRIPTION OF ILLUSTRATIVE EMBODIMENT

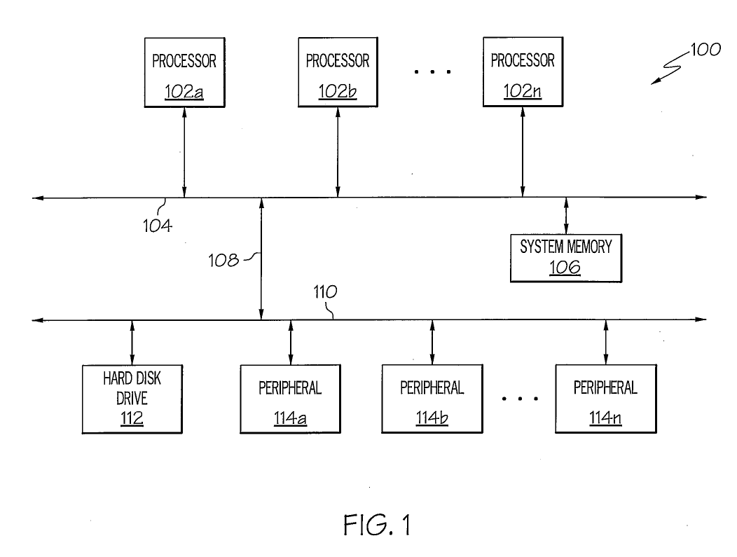

Referring now to the figures, and in particular, referring to FIG. 1, there is illustrated an exemplary data processing system 100 in which an embodiment of the present invention may be implemented. As depicted, exemplary data processing system 100 includes a collection of processors 102a-102n that are coupled to system memory 106 via a system bus 104. System memory 106 may be implemented by dynamic random access memory (DRAM) modules or any other type of random access memory (RAM) module. Mezzanine bus 108 couples system bus 104 to peripheral bus 110. Coupled to peripheral bus 110 is a hard disk drive 112 for mass storage and a collection of peripherals 114a-114n, which may include, but are not limited to, optical drives, other hard disk drives, printers, input devices, network adapters, etc.

Those with skill in the art will appreciate that data processing system 100 can include many additional components not specifically illustrated in FIG. 1. Because such additional components are not necessary for an understanding of the present invention, they are not illustrated in FIG. 1 or discussed further therein. It should be understood, however, that the enhancements to data processing system 100 provided by the present invention are applicable to data processing systems of any system architecture and are in no way limited to the generalized multi-processor architecture illustrated in FIG. 1.

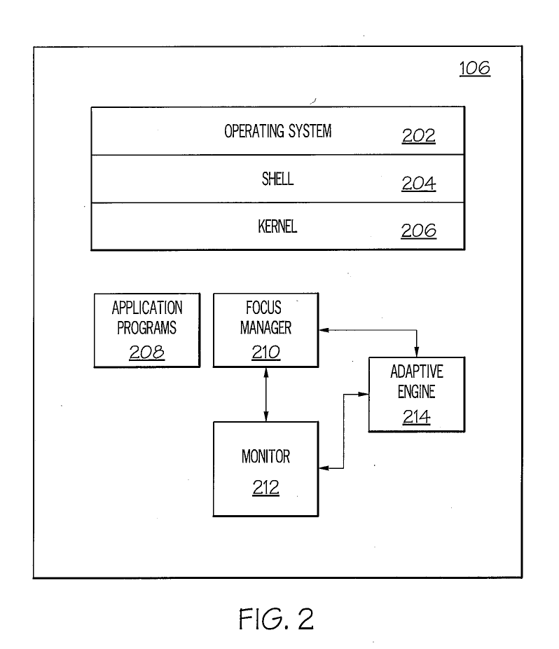

FIG. 2 is a block diagram depicting exemplary contents of system memory 106 of data processing system 100, according to an embodiment of the present invention. As shown, system memory 106 includes operating system 202, which further includes shell 204 (as it is called in UNIX®) for providing transparent user access to resources such as application programs 208. Generally, shell 204, also called a command processor in Windows®, is generally the highest level of the operating system software hierarchy and serves as a command interpreter. Shell 204 provides a system prompt, interprets commands entered by keyboard, mouse, or other user input media, and sends the interpreted command(s) to the appropriate lower levels of the operating system (e.g., kernel 206) for processing. Note that while shell 204 is a text-based, line-oriented user interface, the present invention will support other user interface modes, such as graphical, voice, gestural, etc. equally well.

As illustrated, operating system 202 also includes kernel 206, which includes lower levels of functionality for operating system 202 and application programs 208, including memory management, process and task management, disk management, and mouse and keyboard management. Application programs 208 can include a browser utilized for access to the Internet, word processors, spreadsheets, and other application programs. As depicted in FIG. 2, system memory also includes focus manager 210, monitor 212, and adaptive engine 214.

According to an embodiment of the present invention, focus manager 210 enables a user to delegate focus in an orderly fashion so that the user may view a list of reminders (e.g., messages that would otherwise be displayed in a pop-up window that steals focus from the user's current task) at periodic, configurable intervals.

For example, if the user only wants to view reminders every hour, the user can configure focus manager 210 to display, for example, a single pop-up that shows every reminder that occurred within the last hour. The user can further customize the periodic, configurable interval within the single pop-up. The further customization may be useful in the case when the user is reading a Portable Document Format (PDF) file and does not wish to have pop-ups presenting themselves over the top of the displayed PDF file. While the computer may believe that the user is dormant (e.g., not physically interacting with the computer) when reading a PDF file, the user may still work pop-up free with the further customization.

In addition to presenting a single pop-up, the user may configure more advanced options within focus manager 210 to further customize pop-up presentation. The user can select to queue the pop-ups into a first-in-first-out (FIFO) model, which queues the pop-ups as they are generated by applications within system memory 106. Also, in another embodiment of the present invention, the user can select priorities on pop-ups that would serve to rearrange the order that the pop-ups are displayed to the user by focus manager 210.

For example, IBM Lotus Sametime® is an instant messaging (IM) program. IBM Lotus Notes® is an e-mail/calendar client. A user may assign a priority rating to programs that dictate when pop-ups from these programs are presented to the user by focus manager 210. A user may indicate to focus manager 210 that a Sametime® pop-up from his supervisor has a priority 1 rating and a calendar pop-up from Notes® has a priority 100 rating. Any Sametime® pop-up from the user's supervisor would immediately bypass the queue and is presented immediate on the user's screen. A Notes® calendar pop-up may be presented when the user is, for example, not typing on the keyboard, due to the low priority rating assigned to Notes®.

Monitor 212 examines user activity by categorizing pop-up types and user actions according to Tables 1, 2, and 3.

TABLE 1
Application
Excel ®
Notes ®
PowerPoint ®

TABLE 2
Pop-Up Type
Error (one button to click)
Option (click one of
several buttons)
Input (text and/or radio
buttons + click to ‘ok’
selection”

TABLE 3
User Actions
Defer (x or click away)
Continue
Type + select

As shown, Tables 1, 2, and 3 include three columns: “Application”, “Pop-Up Type”, and “User Actions”. The “Application” table (Table 1) indicates common applications among application programs 208 that issues pop-ups. The “Pop-Up Type” table (Table 2) indicates the typical types of actions that may be taken by pop-ups issued from application programs 208. The “User Actions” table (Table 3) indicates the prior actions taken by the user with respect to particular pop-ups from application programs 208. Any of the applications in Table 1 could display any of the pop-up types in Table 2. Also, the user may have acted on any of the pop-up types from any of the application programs in any of the methods shown in Table 3. Therefore, with an example of 3 applications, 3 pop-up types, and 3 user actions, there are already 27 (=3×3×3) possible outcomes for how a user may deal with any given pop-up.

To facilitate discussion, assume that the user is working on a project that requires the user to combine in to a spreadsheet several pieces of information from different e-mail messages. The user is constantly switching back and forth between Lotus Notes®, an e-mail client, and Microsoft Excel®, a spreadsheet program. The user copies data from an e-mail message in Notes®, switches to Excel®, enters the data into Excel®, and then checks back to the e-mail the verify that the data was correctly entered into Excel®. The project requires a great deal of concentration, but other applications attempt to interrupt the user with pop-ups.

As the user clicks away from or dismisses each pop-up, monitor 212 examines each application that attempts to interrupt the user with pop-ups and notes what action the user has taken in the past to deal with the pop-ups. Those with skill in the art will appreciate that the present invention is not limited to observing three application programs, pop-up types, and user actions, but may track the user's interaction with any number of application programs.

As the user is working between two programs, monitor 212 will observe the following activity (Example 1):

Excel

Notes

Excel

Notes

Excel

Notes

If a pop-up interrupts the user's work, monitor 212 may observe the following activity (Example 2):

Excel

Notes

Excel

Internet Explorer® (IE) option pop-up

Notes

Excel

Notes

If the user took action on the pop-up, monitor 212 may observe the following activity (Example 3):

Excel

Notes

Excel

IE option—select

Notes

Excel

Notes

If the user did not take action on the pop-up, but instead clicks away from the pop-up to return to work, monitor 212 may observe the following (Example 4):

Excel

Notes

Excel

IE option—defer

Notes

Excel

Notes

Example 4 indicates to monitor 212 that the user does not want to be interrupted while using Excel®. If the user chooses to defer an “IE option” pop-up when using Excel® several times in a row, monitor 212 assumes these actions demonstrate a strong preference by the user.

If the “IE option” pop-up occurred during a switch between Excel® and Notes® in Example 4 and the user opted to defer action on the pop-up, monitor 212 creates a “workspace correlation” between Excel® and Notes®. In an embodiment of the present invention, monitor 212 sends “workplace correlation” data to adaptive engine 214 for further processing. A “workplace correlation” is a setting or flag that indicates that the user is switching between two or more applications during a current work session.

Adaptive engine 214 accepts workplace correlation data observe by monitor 212 to adaptively construct rules for handling pop-ups according to user actions. Also, in an embodiment of the present invention, a user may manually set “workplace correlations”, which enables adaptive engine 214 to not allow interruptions from pop-ups when the user is switching between two or more applications.

As previously discussed, in some cases, a user may not be physically interacting with the computer, but the user still does not want to be interrupted by pop-ups. For example, the user may be reading a PDF file and does not want pop-ups to appear over the PDF file. If pop-ups appear over the PDF file, the user may quickly dismiss them, as indicated in the example below (Example 5):

Notes—5 minutes

### User Input

IE option—defer
Notes—5 minutes

### User Input

Notes—1 minute
IE option—defer
Notes—3 minutes

### User Input

### Notes

In Example 5, monitor 212 will notice a pattern that the user appears to be periodically using Notes®, followed by a minimal set of user input every few minutes. The pattern most likely indicates that the user is reading something on the screen and does not wish to be interrupted by pop-ups. Therefore, monitor 212 sends the pattern to adaptive engine 214, which in turn, configures focus manager 210 to increase the time between pop-up presentations to, for example, 10 minutes. Focus manager 210 will continue presenting pop-ups every 10 minutes until this pattern is interrupted or until a new pattern is detected by monitor 212.

FIG. 4 is a high-level logical flow chart illustrating an exemplary method of implementing adaptive window and dialog management according to an embodiment of the present invention. The process begins at step 300 and proceeds to step 302, which illustrates a user working with operating system 202 and application programs 208 via shell 204. The process continues to step 304, which depicts focus manager 210 determining if the user has made a request to adjust settings within focus manager 210. As previously discussed, the user can set a number of parameters including, but not limited to, a time limit to limited the display of pop-ups to a certain time interval (e.g., every five minutes, etc.), a workplace correlation between two or more applications within application programs 208, a priority rating for certain applications within application programs 208 and pop-ups associated to the applications, etc. If the user has not made a request to adjust settings within focus manager 210, the process continues to step 308. If a request has been made to adjust settings within focus manager 210, the process continues to step 306, which illustrates focus manager 210 enabling the user to adjust the settings. In an embodiment of the present invention, focus manager 210 may display a selection menu to enable the user to adjust the settings. The process continues to step 308.

Returning to step 308, focus manager 210 determines by examining the settings set in step 306 whether a pop-up management mode is set to “adaptive” or “static”. If the pop-up management mode is set to “static”, monitor 212 and adaptive engine 214 are not activated since focus manager 210 controls pop-up display utilizing the settings within focus manager 210, as illustrated in step 318. The process ends, as depicted in step 316.

Returning to step 308, if the pop-up management mode is set to “adaptive”, the process continues to step 310, which illustrates monitor 212 monitoring user activity to establish “workspace correlations” or other usage patterns. For example, as discussed above, if the user is constantly deferring or dismissing pop-ups while switching between two applications, monitor 212 and adaptive engine 214 may establish a “workspace correlation” that determines that the user does not wish to be interrupted while working between those particular applications. Likewise, if the user is seemingly idle, yet constantly defers or dismisses pop-ups when they appear, monitor 212 and adaptive engine 214 may determine that the user is displaying a usage pattern that may indicate that the user is reading a document or watching a video on the screen and does not wish to be interrupted by pop-ups. The process continues to step 312, which indicates adaptive engine 214 receiving the workspace correlations and usage patterns determined by monitor 212 and adapting the pop-up management settings within focus manager 210 to enable focus manager 210 to manage pop-up presentation. The process continues to step 314, which illustrates focus manager 210 determining if the process should end. If not, the process returns to step 310. If the process (e.g., work session, etc.) has ended, the process continues to step 316, which depicts the process ending.

As discussed, the present invention includes a system and method for implementing adaptive window and dialog management on a data processing system. A user interface enables a user to interact with a primary program and at least one secondary program, and wherein the at least one secondary program notifies the user of at least one condition that request user attention via at least one pop-up window that steals focus from the primary program by placing the at least one pop-up window in a foreground position and redirects all user input to the at least one pop-up window. A monitor establishes usage patterns of the user while utilizing the user interface. A focus manager and adaptive engine utilize the usage patterns from the monitor to adaptively manage display of the at least one pop-up window.

It should be understood that at least some aspects of the present invention may alternatively be implemented in a computer-usable medium that contains a program product. Programs defining functions in the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory, such as, but not limited to random access memory (RAM), and communication media, such as computer and telephone networks, including Ethernet, the Internet, wireless networks, and like networks. It should be understood, therefore, that such signal-bearing media, when carrying or encoding computer-readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention.

What is claimed is:

1. A computer-implementable method for implementing adaptive window and dialog management on a data processing system, said method comprising:
implementing a user interface on a data processing system, wherein said user interface enables a user to interact with a primary program and at least one secondary program, and wherein said at least one secondary program notifies said user of at least one condition requiring user attention via at least one pop-up window that steals focus from said primary program by placing said at least one pop-up window in a foreground position and redirects all user input to said at least one pop-up window;
establishing usage patterns of said user while using said user interface; and
utilizing said usage patterns to adaptively manage display of said at least one pop-up window.

2. The computer-implementable method according to claim 1, wherein said establishing usage patterns of said user further comprises:
examining said user interaction with said at least one pop-up window while said user interacts with said primary program and said at least one secondary program.

3. The computer-implementable method according to claim 1, wherein said establishing usage patterns of said user further comprises:
establishing a workplace correlation between said primary program and said at least one secondary program.

4. A data processing system, comprising:
at least one processor;
a databus, coupled to said at least one processor;
a computer-usable medium embodying computer program code, the computer-usable medium being coupled to the data bus, the computer program code comprising instructions executable by the processor and configured for:
implementing a user interface on a data processing system, wherein said user interface enables a user to interact with a primary program and at least one secondary program, and wherein said at least one secondary program notifies said user of at least one condition requiring user attention via at least one pop-up window that steals focus from said primary program by placing said at least one pop-up window in a foreground position and redirects all user input to said at least one pop-up window;
establishing usage patterns of said user while using said user interface; and
utilizing said usage patterns to adaptively manage display of said at least one pop-up window.

5. The system according to claim 4, wherein said instructions for establishing usage patterns further include instructions further configured for:
examining said user interaction with said at least one pop-up window while said user interacts with said primary program and said at least one secondary program.

6. The system according to claim 4, wherein said instructions for establishing usage patterns further include instructions further configured for:
establishing a workplace correlation between said primary program and said at least one secondary program.
